(19) United States
(12) Patent Application Publication
(10) Pub. No.: US 2023/0292406 A1
(43) Pub. Date: Sep. 14, 2023

(54) SPECIAL ELECTRODE ARRANGEMENT FOR THE TARGETED OHMIC HEATING OF DIFFERENT PRODUCTS OR STRUCTURES THAT ARE ELECTRICALLY CONDUCTIVE OR CONTAIN ELECTRICALLY CONDUCTIVE CONSTITUENTS

(71) Applicant: Fritz Kortschack, Oldenburg (DE)

(72) Inventor: Fritz Kortschack, Oldenburg (DE)

(21) Appl. No.: 18/017,820

(22) PCT Filed: Aug. 11, 2021
(86) PCT No.: PCT/EP2021/072348

§ 371 Date: Jan. 24, 2023

(30) Foreign Application Priority Data
Aug. 12, 2020 (DE) 10 2020 121 251.8

(51) Int. Cl. H05B 3/03; H05B 3/68; H05B 3/00; H05B 3/40

(52) U.S. Cl. CPC H05B 3/03; H05B 3/68; H05B 3/0023; H05B 3/40; H05B 2203/022; F24H 3/002

(57) ABSTRACT

The invention relates to a special electrode arrangement for the targeted ohmic heating of different products, media or structures that are electrically conductive or contain electrically conductive constituents and have an inorganic or organic basis, including products of plant or animal origin, consisting of at least one electrode group comprising a plurality of individual electrodes. According to the invention, the individual electrodes are arranged at a distance apart from one another in an insulating carrier and, with the exception of an electrode surface region, are insulated from the product to be treated or the structure to be treated.

The invention relates to a special electrode arrangement for the targeted ohmic heating of different inorganically or organically based products or structures that are electrically conductive or contain electrically conductive constituents, including products of plant or animal origin, consisting of at least one electrode group comprising a plurality of individual electrodes according to claim 1.

A device for electrically rapidly heating foodstuffs is already known from DE 15 40 909 A, wherein the heating is performed by high-frequency alternating current passing axially through a corresponding foodstuff. The alternating current is supplied by contacts at the ends or front sides of the oblong foodstuff to be treated. The relevant non-conducting or poorly conducting wrapping of the foodstuff is penetrated. The electrodes employed can have point-shaped or cutter-shaped protrusions at the contact surfaces so that the wrapping can be easier punctured.

The matter in the device for heating foodstuffs according to DE 10 2015 206 385 A1 preferably is treating wrapped products, in particular meat and sausage products. This teaching intends to realize a rapid heating of the wrapped foodstuff by means of uniformly applying electrical current, which generates heat within the foodstuff.

The known device has at least two spaced, axially parallel cylindrical electrodes which can rotate in the same direction, and are contacted to the connections of opposite polarity of an electrical current source and are in electrical contact with the wrapping, wherein the electrodes rotate at the wrapping. The current source according to DE 10 2015 206 385 A1 provides alternating current having a frequency in the range from 2 kHz to 300 MHz.

The document DE 10 2014 010 166 A1 takes a method for treating a foodstuff by heating as a basis. In this case, non-conventional ohmic heating is used.

The functional principle of ohmic heating refers to directly conducting current through the product. In this case, the foodstuff quasi adopts the function of a resistor. The movement of electrons or ions generates frictional heat, with additional electric fields acting

According to DE 10 2014 010 166 A1, filling of a dimensionally stable wrapping of a non-conducting material, which is dimensionally stable or is dimensionally stabilized by further means, with a filling material is first performed. In this case, it may be sausage meat or a similar foodstuff raw material. Following this, the openings of the wrapping are closed by means of conducting surfaces, in particular plates or plugs. The electrical current is supplied over the conducting surfaces for the purpose of ohmic heating.

In a configuration according to DE 10 2014 010 166 A1, the product of treatment can be partitioned into sections within the wrapping by conducting boundaries, for example, discs of conducting material. These conductive boundaries result in a homogenization of the current flow and thus in a uniformization of the ohmic heating.

All of the above-mentioned solutions have in common that the heating by ohmic heating depends on the conductive paths within the product to be treated, i.e. the product resistance. Usually, this resistance is not homogenously distributed over the volume of the good or product to be treated. This results in greater currents flowing in partial branches of lower resistance, with the result of excessive heating in these branches, and insufficient heating or overly prolonged treatment time in branches of higher resistance.

From the aforementioned, it is therefore a task of the invention to propose a special electrode arrangement, which avoids the shortcomings of the state of the art and allows novel, hitherto unknown fields of applications for the technological area of ohmic heating.

The solution of the task of the invention is performed according to the electrode arrangement in the feature combination according to claim 1, the subclaims including expedient further developments and applications.

Accordingly, a special electrode arrangement for the targeted ohmic heating is taken as a basis. In this case, different inorganically or organically based products or structures that are electrically conductive or contain electrically conductive constituents are intended to be treated. Likewise, the treatment of products of plant or animal origin is intended to be possible. The electrode arrangement consists of at least one electrode group comprising at least two individual electrodes which are preferably formed as physical contact electrodes.

Preferably, a plurality of electrode groups each having a plurality of individual electrodes is provided so as to be able to heat or treat spatially or, as far as the volume is concerned, larger products or structures sufficiently by ohmic heating in a technologically appropriate short time.

The electrodes according to the invention can be combined with the electrodes of the state of the art depicted in the introductory description, in particular with such electrodes, which penetrate on the volume or surface.

The formation of the electrodes according to the invention enables ohmic heating in combination with further well-known methods of treating products, such as, for example, the so-called electric perforation of plant or animal cells and products to be treated accordingly, the treatment by means of high pressure for reducing germs and/or the treatment by means of ultrasound for modifying the structure of the product of treatment, for example, for compacting.

If, for instance, the electrode arrangement is applied in conjunction with the technology of ohmic heating prior to, alternating with or after an electric perforation, cell walls can be broken and the broken state can be maintained. Furthermore, cell liquid is released, which in turn reduces the resistance value of the product of treatment with the further consequence of a potential reduction but also shortening of the treatment time for ohmic heating.

In a further development of the invention, the electrode arrangement has an electrode group consisting of a plurality of mutually insulated individual electrodes having a punctiform, circular or radiant formation. The individual electrodes optionally are interconnectable and electrically controllable directly individually or in a subset or the total set of the individual electrodes.

This individual interconnectivity or the individual control abilities of the electrodes of an electrode group allow changing resistance values or resistance values decisive for the product or structure to be responded to.

Here is also the possibility to initially use such an electrode group as measurement electrodes so as to determine a surface resistance or a specific resistance and its changing over a surface, in order to initiate thereafter the control of the electrodes in such a manner that the product of treatment is heated as homogenously as possible and the desired product quality is reached or remains assured.

In a further embodiment of the invention, the individual electrodes are inserted or embedded in a concave half shell-like or shell-like carrier.

The individual electrodes can be disposed to be relatively moveable in the carrier.

According to the invention, the individual electrode may be a component of a shaping body with respect to the product of treatment or of a shaping wrapping, wherein the individual electrodes with respect to the body or the wrapping can be movably shifted relative to it. Thus, the product to be treated can be introduced into the shaping body. In the next step, the electrodes can then be brought into their desired treatment positions, and the treatment on the basis of ohmic heating can begin.

In this case, there is the further possibility to shift the electrodes during the treatment in their positions relative to the shaping body and thus toward the product of treatment, for example, to slowly retract them into their initial position. This allows any puncture holes that may be present to close again.

The shaping body or the wrapping can be configured to be applied with pressure or be in association with an ultrasound-generating means so as to enable a treatment of the product in conjunction with the ohmic heating in this respect.

The electrodes may consist of a metallic material, of conductive plastics or conductive ceramics or contain such materials. In this case, special aspects of the product of treatment can be taken into account, for example, according to legal regulations in foodstuff technology but also according to the provisions and regulations in treating human or animal tissue, in particular with respect to forming sterile or sterilizable electrodes. With respect to the product of treatment, the surfaces of the electrodes can be provided with an antistick coating.

The electrodes can consist of a core material having a conductive coating, wherein the so-called skin effect is aimed at via the conductive coating during a corresponding alternating current treatment of the product of treatment. Insofar, only the conductive coating needs to be realized to be as highly conductive as possible. The electrode core or the material receiving and carrying the wrapping may be selected or optimized under a mechanical aspect but also under the cost aspect.

As already briefly mentioned, the electrode arrangement according to the invention may be in association with a device for electric perforation (PEF), wherein at least one electrode pair is a component of the electric perforation device or can at least temporarily be interconnected in this respect.

The special electrode arrangement according to the invention for targeted ohmic heating is in particular used in the field of foodstuff technology, for the surgical treatment of humans or animals, in the building industry for drying buildings or building parts, in the catering trade for heating foodstuffs, for drying or compacting biological or chemical wastes, but also in the field of heating and air-conditioning technology.

The invention will be explained in more detail below by means of exemplary embodiments and further advantages as well as application aspects.

In the field of surgical, respectively medical treatment of humans or animals, the special electrodes with needle-shape may serve to denaturize tissue by targeted heat application. This may be done in a minimally invasive manner.

A particular advantage is that, when miniaturized needle electrodes are used, only a small area comes into contact with the tissue to be treated, which minimizes the treatment risk and improves the treatment success. Side effects by cuts or also germs introduced during surgery can be reduced.

The special electrode arrangement can be arranged, for example, in a circular manner or quasi radially around a center point.

In this respect, the individual electrodes can be activated in a switching circuit technological manner without an electrode change occurring so as to reach, for example, layers outside the shaping to be treated. But alternatively, there is also the possibility to exchange an electrode, for example, by an electrode of another geometry.

The treatment zones may map any desired shape such as, for example, rectangles, stripes, layers, tubes, round bars or figures symbolizing a certain occasion such as, for example, a Santa Claus, an Easter Bunny, a logo of a heart, or similar.

In the technical field, there is the possibility to activate adhesives or curing filling masses or similar by areal or punctual heating by means of the electrode arrangement in a targeted manner. Due to the use of hollow needle electrodes, prior to, during or after the ohmic heating, substances, e.g. catalysts, can be injected into the product of treatment in a targeted manner through the hollow needles and likewise be thermically treated.

The treatment of a product is also possible in a special mold, a shaping body. Here, the electrodes may already be implemented within the mold or within the body, or may be introduced into the product of treatment or also be retracted again by means of breakthroughs in the mold.

The mentioned treatment may also take place in an open mold so that within the mold or after ejecting the product of treatment, a surface treatment by additional means such as, for example by wetting with liquid smoke, spice addition, color, but also by heating in the form of burning off, frying or by means of cold treatment may be performed.

For influencing the density of the product of treatment, the product may be subjected to a positive or negative pressure during the treatment by means of ohmic heating.

Due to positive pressure, a more solid consistency is generated and prevents cavities from being formed within the product, i.e. the product of treatment, in which liquid may undesirably collect with the result of a changed or even interrupted current flow.

In an application by negative pressure, a desired foamy or fluffy consistency of the product of treatment may be stabilized or achieved such as it is required, for example, in bread, cake, parfait or similar preparations.

Sausage meat mass may be filled loosely into a current-permeable wrapping (a natural wrapping). This is then sucked, inserted or layered into a negative mold.

By putting on a closely sealing cover mold and applying a vacuum within the intermediate space, the filling product positioned within the wrapping expands and is delimited by the wrapping itself.

By means of adapted electrodes in the interior of the intermediate space, the expanded mass may be heated and thus dimensionally stabilized by means of ohmic heating.

In a similar manner as explained above, sausage meat may be introduced into a negative mold. By putting on a sealing cover mold and applying a vacuum, the product of treatment may be subjected to expansion delimited by the molds. The application of alternating current into the product of treatment by means of the contacts positioned within the intermediate space then leads to the ohmic heating, with the result of dimensionally stabilizing the product to be treated.

The product of treatment may have a direct contact with the mold, for example, in the form of skin-free sausage, but may also be in a non-conducting shell, for example, for a pâté or similar.

During the treatment of single zones within the product of treatment by electrodes introduced into the volume, there is the possibility to realize different densities within the product of treatment by changing the pressure, which results in the specific resistance changing in this area. Here, an adaptation of the application of alternating current may then be performed, so as to shorten the treatment time with the same treatment result, or else to intensify a treatment.

It is within the field of application of the invention to encase temperature-sensitive drugs by a mechanically more solid layer which can be brought to higher temperatures, or vice versa. In this respect, as well, a solidification of the wrapping may be performed by ohmic heating.

In case of a product of treatment positioned in closed or open molds, such as, for example, cold cut meat, sausage meat, pickled meat for boiled ham production, smoked pork chop raw products or non-pretreated roast pieces, a heating may be performed with the aid of the electrodes even at problematic positions such as curves, for example. In this case, the electrodes may form a geometric wrapping curve corresponding to the structure or the shape of the product to be treated so that a corresponding uniform heating can be performed.

Inserted molds may be joined to one another so as to simplify a treatment of small-sized products.

Boiled sausage meat or bratwurst meat may be filled into joined lower molds. Air above the product of treatment is removed prior to putting on the exactly fitting mold covers provided in particular with brush electrodes, so that during the treatment of ohmic heating, the sausage meat is exposed to pressure and in the final product, a solid air pocket-free consistency is present.

After such a treatment, which is also suitable for sausage meat positioned within a wrapping, the warm raw products may be surface treated or be packed in a warm untreated state. In case of sausages, the surface treatment may be performed by liquid smoke. For the final germ reduction of the packed products, a possibly further, short-term heat treatment takes place.

In contrast to the hitherto known heating methods, the heating according to the invention does not take place from the outside to the inside but at the same time and homogenously in the entire product of treatment. Therefore, no areas are formed which are exposed to a prolonged or too intensive heat. Also, with respect to a microwave treatment, the penetration depth of which is delimited, the ohmic heating according to the invention exhibits remarkable advantages such as, for example, reduced process time in case of larger calibers, reduced process loss and uniform heat penetration within the product of treatment without any dry edge layers resulting from radiant heat.

Foodstuffs may be subjected to electric perforation (PEF treatment) prior to the treatment by means of ohmic heating. The heating occurring during such a treatment is harmless for further treatment or desired for pre-heating the raw product. By the PEF treatment, holes are generated in the cell membranes. Through the association of extracellular liquid and intracellular liquid, the bonding capacity, i.e. the consistency of the product is increased, for example, in a boiled sausage meat. The used stabilizing substances such as phosphate, milk protein or the like may be reduced and, depending on the recipe, may even be omitted completely.

The advantage of this combined treatment is the fact amongst others that microorganisms are damaged at least sublethally by the PEF treatment.

Since cell tissues after some time, due to quasi self-healing powers, tend to close again the perforations caused in the cell wall, a PEF treatment with a subsequent heat treatment on the basis of ohmic heating is advantageous. The protein coagulation occurring in this case prevents the cell perforations from closing again.

Before rigor mortis sets in, an undesired muscle shortening may be prevented by applying the ohmic heating in meat at slaughter temperature, and thus the tenacity of the raw product may be influenced.

Since warm meat reacts very sensitively to external influences such as coldness, heat, electrostimulation or the like by muscle shortening before rigor mortis sets in, a corresponding ohmic heat in the warm meat in combination with a pressing power is advantageous, namely for preventing muscle shortening after the slaughter process by the meshing of filaments.

If warm meat is clamped in an intrinsically known pressing device in such a manner that the filaments cannot mesh, this state can be quasi preserved and “frozen” when an ohmic heating takes place by electrodes of the type according to the invention, and hereby the protein of the product of treatment coagulates thus far that a biochemical change of the muscles can no longer take place after the meat has been removed from the pressing device.

The method mentioned above offers many advantages such as short process times, low drying losses, smaller storage surfaces, and a lower microbial load.

The ohmic heating can be combined with the PEF treatment mentioned above, which contributes to damaging microorganisms despite the relatively low thermal impact in such a manner that a propagation of these undesired microorganisms is prevented or delayed.

The combination of the PEF treatment with ohmic heating makes shortly ripened raw sausages safer in that salmonella, listeria, viruses or the like are inactivated.

The ohmic heating on the basis of the presented electrodes quite fundamentally offers itself for inactivating spore formers. By heating a product of treatment almost at all points simultaneously and very rapidly, current-conducting products, such as, for example wetted herbs are heated inside the product to an extent that germinating of spore formers is provoked due to the occurred stress by the heat treatment. The product treated in such a manner undergoes a significant reduction in germs by means of a subsequent, time-delayed renewed heat treatment by means of ohmic heating at higher temperatures, which again acts rapidly in the entire product of treatment, namely by damaging and inactivating the germinated spores.

Here, it is also possible to subject the product of treatment promptly to a high-pressure treatment for inactivating or damaging the germinated spores.

This high-pressure treatment may also be performed at the beginning of the treatment chain and encourage the spore formers to germinate by stress.

By the “relatively slow” heat progression from the outside to the inside, hitherto known heating methods lead to the fact that at least a part of the spores is able to prepare for the subsequent heat treatments and an undesired encapsulation occurs.

The heat treatment mentioned above by means of ohmic heating may take place before a PEF treatment.

Further embodiments and ideas according to the invention will be explained below.

Basically, there is the possibility to arrange the individual electrodes in the carrier to be movable relative to one another, in particular to be shiftable.

In a further development in this respect, the electrodes may be configured as a tube or rod bundle, wherein at least parts of the bundle are mutually shiftable. Hereby, in relation to the product, this may be shaped. The bundle, for example, by retracting middle tubes or rods, may achieve approximately a concave shape which is then transferred to the attached product to be treated and shapes it in a convex fashion at its ends. In the same sense, middle tubes or rods can be arranged to be projecting as compared to adjacent rubes or rods in order to provide the product to be treated with a concave shape. The product to be treated can thus be individualized, for example, on the side of the application or manufacture-specific.

With respect to the product to be treated, the individual electrodes may be a component of a shaping body or of a shaping or temporally stabilizing wrapping.

With respect to the body or the wrapping, the individual electrodes may be realized to be movable to it.

In particular, with a cylindrical wrapping shape, openings may be present in the wrapping, through which the individual electrodes penetrate end enter into the product to be treated which is situated within the wrapping, and pierce it, if necessary, up to an opposite opening in the wrapping. When the desired treatment, this is the ohmic heating, is performed, the individual electrodes are withdrawn from the product to be treated through the wrapping. Such a treated, in particular heated product, for example, in the form of a sausage meat or a sausage mass, may subsequently be transferred from the previously mentioned wrapping into a consumption or sales package, in particular a casing, which is then closable at its ends in a known manner.

In order to prevent an undesired adhesion of constituents of the product, for example, of protein to the individual electrodes, the individual electrodes are designed to be tempered, in particular cooled. Thereby, it is prevented that the electrodes themselves are subjected to too strong a heating when the product of treatment is heated.

At least one of the individual electrodes of the special electrode arrangement in one configuration of the invention may have openings or channels for introducing or injecting spices, contrast agents, means for preservation or such similar means into the respective product.

A further development according to the invention is to perform by means of the electrode arrangement a targeted static charging or a targeted static discharging of the product to improve a subsequent surface treatment of the product. Such a later treatment may comprise, for example, a treatment with liquid smoke, smoulder smoke, or else the application of pulverized cultures.

The spaced individual electrodes located in particular in the isolating carrier may also be formed by means of a mask from a full electrode arrangement. The mask has open spaces giving access to certain portions of the full space electrode for the product to be treated.

In an alternative embodiment, there is the possibility to make milling grooves in the respective electrode. Into the milling grooves, insulating materials may then be introduced as a filling. Hereby, as well, a structure having individual electrode portions is developed.

An advantage in the formation of individual electrodes while referring to a carrier or a structure of great heat capacity is that a too strong heating of the electrodes with the disadvantageous consequences of sticking of the product to be treated is a priori avoided.

Quite basically it should be pointed out that by means of the introduced special electrode arrangement there is also the possibility to heat liquid having a certain conductivity extremely rapidly. In this sense, also hot vapor may be generated. If the presented electrode arrangements, for example, are introduced into a pressure-tight and pressure-resistant vessel or are arranged correspondingly, a liquid received within the vessel or to be introduced into the vessel may be transferred into a vaporous state. Hereby, smaller consumption amounts of vapor may be directly generated at the site of consumption. Longer transport paths for hot vapor having the respective energetic losses are omitted.

It is in the meaning of the invention to use the presented electrode arrangement also for heating dishes or keeping dishes warm. When such a solution is used, it would no longer be necessary to very long and intensely pre-heat or keep warm dishes, for example, by infrared irradiation, for example, in public places, canteens, restaurants or similar. By heating the corresponding dishes directly before consumption, taste, haptic and optical components remain unchanged, which promotes consumption.

For the case gases exit from the product to be treated or gases develop during the treatment in heating the respective product while referring to the presented electrode arrangement, there is the possibility of arranging diaphragms, in particular semipermeable diaphragms. On the one hand, the respective diaphragms must then ensure that the necessary current flow is not impeded, for example, by recesses according to the electrode configuration. On the other hand, the diaphragms allow gases to penetrate to a corresponding outlet opening preferably arranged within the carrier or the wrapping, and namely without the product to be treated to escape itself.

For the case that the possibly developing gas amounts are minimal, the semipermeable diaphragms may be provided with a volume acting as a gas storage. After the respective treatment process, the gas storage may be emptied.

If, caused by the gas storage, the diaphragm is extended, the result will be a pressure increase in the described arrangement with the consequence of a compaction in the product to be treated just in the area of the of the active electrode arrangement. This promotes conductivity, improves the characteristics of the product and serves the densification in the respective portion of the arrangement of the diaphragm having gas storage possibility.

Further aspects according to the invention will be explained hereinafter.

A further development of the invention is that the electrode arrangement is configured in this way, wherein the electrode tips, electrode ends or certain electrode portions have an insulating wrapping that can also be removed.

The insulating wrapping serves for the targeted influencing of the developing current paths when a corresponding current is applied for the purpose of ohmic heating.

In particular also with respect to this embodiment, there is the possibility to allow the electrodes to submerge variably deep into the product or the medium to be treated, or the supply of the electrodes over sections of differentiated configurations with the corresponding medium.

Thus, a restricted heating of one layer in the corresponding medium is possible. This only partial heating of the product of treatment helps to ensure that only that actually need to be heated are subjected to a corresponding energy supply.

Moreover, there is the possibility to carry out a separation of the heated layer from a non-heated layer. In this respect, a separating device may be provided. It may also be in constructional connection to the electrodes.

The separating device may be spatially displaced together with the rod electrodes during the withdrawal of the warm or heated product of treatment, in particular of a fluid. In this respect there is a possibility of mixing, for example, with post-filled, still cold product of treatment then, when a hot water preparation on the basis of ohmic heating is desired.

Below the actual separating device which can be designed as a diaphragm, there is the possibility to form a flexible isolating arrangement. This may be achieved in conjunction with the already depicted wrapping of the rod electrodes.

A further possibility of controlling the degree of heating, in particular the heating of fluid media, is the fact to control the throughflow amount. Depending on the supplied performance for ohmic heating, the throughflow rate may be increased per unit of time but also reduced. The target here is to technically realize the desired heating at a minimum or appropriate use of energy. In this respect, the previously mentioned separating diaphragm may be configured to release a larger cross-section of a vessel formed in the sense of a flow heater or to reduce this cross-section.

In this respect, separating layer plates may be used if the inflow of the still cold liquid to be heated is released by the respective separating layer plate.

With regard to the movability of the separating membrane and the therewith created variant for controlling the throughflow amount or the medium to be heated per unit of time, it is possible that after the product of treatment has been withdrawn, almost no unnecessarily heated amounts remain unused within the system.

Due to this kind of controlling the influence of the amount of the medium to be heated, when the hot water is heated and processed, for example, the hitherto necessary mixing in of cold water for preventing an overtemperature when the heated medium is withdrawn, may be renounced of.

A further advantage is the fact that by the responsive ohmic heating, a central hot water preparation of larger amounts may be renounced of. Rather, a heating of small and smaller amounts according to the consumption to be expected can be changed in a decentralized manner and on site.

Summarizing the above aspects, the electrodes can thus immerge variably deep into the product or medium to be treated or be surrounded by it. Furthermore, a separating device for adjusting or regulating the amount to be heated by the ohmic heating may be formed within the medium or the product.

For the case of heating fluid media, in particular water or similar substances, there is the possibility to arrange flow conducting devices within a vessel which moreover receives the electrodes for ohmic heating.

These flow conducting devices may be realized to be fixed or else movable and adjustable so as to allow an optimum flow around the electrodes. Alternatively, by such conducting devices, a control of the maximum or minimum input but also of the output, i.e. the withdrawal amount per unit of time, may be realized.

The previously mentioned separating device can be adjusted and changed in its position in a mechanical WAY i.e. per hand, but also pneumatically, hydraulically, or electromotively so as to take an influence on the flow around of the electrodes or the passage rate. This kind of adjustment can replace or complement an otherwise complicated electrical circuitry or adjustment of a group of electrodes.

According to a further development according to the invention, the individual electrodes may be a constituent of a heating surface structure or a heating plate structure receiving the product or medium or containing the product or medium, wherein the heating surface structure or heating plate structure is usable in different technical fields of application as heat-radiating elements.

The heating surface structure or heating plate structure can have a sandwich construction and be respectively tempered differently.

Moreover, there is the possibility to form the heating surface structure or heating plate structure as a plurality which can be two-dimensionally/spatially strung together, and wherein these are individually controllable or controllable separated in groups.

A preferred use of the previously explained embodiment is in the area of aeration or deaeration systems for air-conditioning, here in particular buildings, and in turn in particular in buildings that are operated in an energy self-sufficient way or are provided with energy recovery systems from the building exhaust air.

Insofar it is thus possible to utilize the principle of ohmic heating for operating heating elements which have a corresponding medium that can be energetically activated by ohmic heating. These heating elements can be realized as double plates having electrodes.

The mentioned stringing together of separate heating plates or heating plates that are controllable in groups enables, for example, by outputting radiation heat, to realize a ceiling heating or wall heating differently tempering or heating defined areas.

Thus, areas can be provided with a higher radiation heat in a targeted way, whereas other areas are less heated.

The described heating surfaces or heating plates can be provided on one side with a highly dampening cover or wrapping, e.g. vacuum insulation panels, and be correspondingly installed so that the result is an advantageous use in the field of construction of so-called tiny houses.

In this case, the heating surfaces or heating panel structures do not need to consist only of rigid structures but may likewise be realized film-like or flexible and hereby have different spatial designs or geometries.

Such heating surface or heating plate structures may complement or else replace present classical heating systems in buildings or comparable facilities. There is in particular the possibility to use heat plate structures, e.g. in supply air channels for heating inflowing air in case of forced-air premises or objects.

1. A special electrode arrangement for the targeted ohmic heating of different inorganically or organically based products, media or structures that are electrically conductive or contain electrically conductive constituents, including products of plant or animal origin, consisting of at least one electrode group comprising several individual electrodes,
characterized in that
the individual electrodes are arranged spaced from one another in an insulating carrier and are designed to the insulated with respect to the product, medium or structure to be treated with the exception of an electrode surface area.

2. The electrode arrangement according to claim 1,
characterized in that
the carrier serves the purpose of directly shaping the product or structure or indirectly of supporting such a shaping.

3. The electrode arrangement according to claim 1,
characterized in that
the electrode group has a plurality of mutually insulated individual electrodes having a punctual, circular or radially or radiantly formation extending around an imaginary center point, and the individual electrodes can be interconnected and electrically controlled optionally individually, in a subset of the individual electrodes, or at the same time.

4. The electrode arrangement according to claims 1,
characterized in that
the individual electrodes are embedded in a convex, concave, half shell-like or shell-like carrier.

5. The electrode arrangement according to claim 1,
characterized in that
the individual electrodes are arranged within the carrier to be relatively movable, in particular, slidable.

6. The electrode arrangement according to claim 2,
characterized in that,
with respect to the product of treatment, the individual electrodes are a component of a shaping body or a shaping wrapping, wherein the individual electrodes, with respect to the body or the wrapping, can be realized to be movable relative to it, or are formed to be puncturing or penetrating the body or the wrapping and to be retractable.

7. The electrode arrangement according to claim 1,
characterized in that
the individual electrodes consist of a metallic, electrically conductive material, of conductive plastics or conductive ceramics or contain such materials, and the electrode surface is provided with an anti-stick coating with respect to the product of treatment.

8. The electrode arrangement according to claim 1,
characterized in that
the individual electrodes consist of a core material having a conductive coating or wrapping, wherein the so-called skin effect is aimed at via the conductive coating or wrapping and during application of alternating current to the product of treatment.

9. The electrode arrangement according to claim 1,
characterized in that
these are introduced or are introducible as stripe electrodes into the insulating carrier that is shaping with respect to the product of treatment.

10. The electrode arrangement according to claim 1,
characterized in that
at least one of the individual electrodes is formed as an electrode for measuring physical or electrical characteristics of the product of treatment.

11. The electrode arrangement according to claim 1,
characterized in that
it is in association with a device for electric perforation, wherein at least one individual electrode is a component of the electric perforation device or can be electrically interconnected with such an electrode.

12. The electrode arrangement according to claim 1,
characterized in that
at least one of the individual electrodes is formed to be tempered, in particular cooled.

13. The electrode arrangement according to claim 1,
characterized in that
at least one individual electrode has openings or channels for introducing or injecting spices, contrast agents or means for preservation into the respective product.

14. The electrode arrangement according to claim 1,
characterized in that
it allows to execute a targeted static charging or discharging of the product for improving a subsequent surface treatment thereof

15. The electrode arrangement according to claim 1,
characterized in that
it is designed as a tube or rod bundle, wherein at least parts of the bundle are mutually shiftable and hereby, in relation to the product, are realized to as to be able to shape it.

16. The electrode arrangement according to claim 1 ,
characterized in that
the electrode tips or electrode ends have an even removable insulation wrapping for the targeted influencing of generating current paths.

17. The electrode arrangement according to claim 1,
characterized in that
the electrodes submerge variably deep into the product or medium to be treated or are surrounded by it.

18. The electrode arrangement according to claim 17,
characterized in that
a separating device is formed in the medium or product for adjusting or regulating the amount to be heated by the ohmic heating.

19. The electrode arrangement according to claim 1,
characterized in that
the electrodes are constituents of a heating surface structure or a heating plate structure which receives or contains the product or medium, wherein the heating surface structure or heating plate structure can be used in different technical fields of application as heat-radiating elements.

20. The electrode arrangement according to claim 19,
characterized in that
the heating surface structure or heating plate structure has a sandwich construction and can be tempered differently.

21. The electrode arrangement according to claim 19,
characterized in that
the heating surface structure or heating plate structure is formed as a plurality which can be two-dimensionally/spatially strung together, and be controlled individually separated in groups.

22. The electrode arrangement according to claim 19,
characterized in that
it is integrated in an aeration or deaeration system for performing air-conditioning in particular in buildings.
